(19) United States
(12) Patent Application Publication
(10) Pub. No.: US 2026/0189395 A1
(43) Pub. Date: Jul. 2, 2026

(54) System and Method for Secure Mobile Photo Exchange Application

(71) Applicant: Anthony Hiroshi Chogyoji, Perris, CA (US)

(72) Inventor: Anthony Hiroshi Chogyoji, Perris, CA (US)

(21) Appl. No.: 19/007,320

(22) Filed: Dec. 31, 2024

(51) Int. Cl. H04L 9/32; H04L 9/08

(52) U.S. Cl. CPC H04L 9/3228; H04L 9/0863; H04L 9/0869

(57) ABSTRACT

This invention utilizes one-time use, time-limited codes to eliminate the need for physical device exchange and handover for taking photos for other users; utilizes encrypted communication for secure device-to-device data exchange through a cloud-based server/broker service; and features permission controls allowing users to manage access.

### BACKGROUND OF THE INVENTION

Problem: The current methods for exchanging photos with strangers (e.g., swapping phones, using social media) pose security and privacy risks. Sharing personal devices exposes sensitive data, while public platforms lack granular control over access.

Solution: This invention provides a secure and private method for exchanging photos between strangers using a time-limited, permission-based one-time code generated by a mobile application. This eliminates the need for physical device exchange and enhances user control over photo access.

### SUMMARY OF THE INVENTION

A mobile application enables two users to exchange photos securely without exchanging devices. The application generates a unique, time-limited code that grants temporary access for photo exchange. The code is only valid for a specific transaction and within a defined timeframe. After the exchange or expiration, the code becomes invalid, preventing further access.

### BRIEF DESCRIPTION OF DRAWINGS

FIG. 1: Flowchart illustrating the code generation and exchange process.

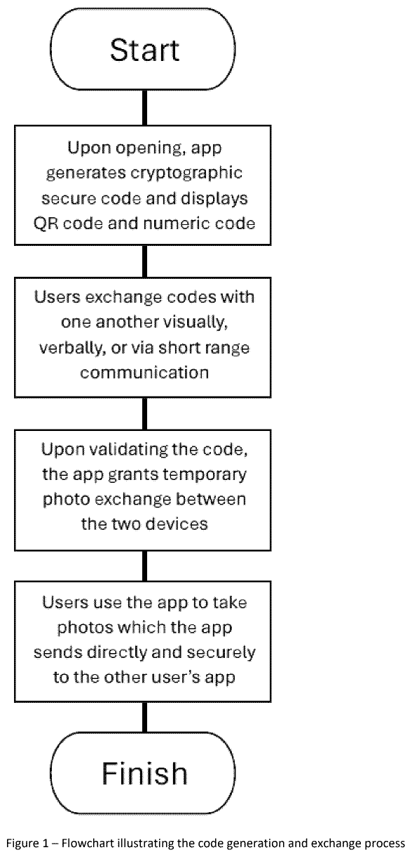

FIG. 2: Screenshot of the app interface showing code generation.

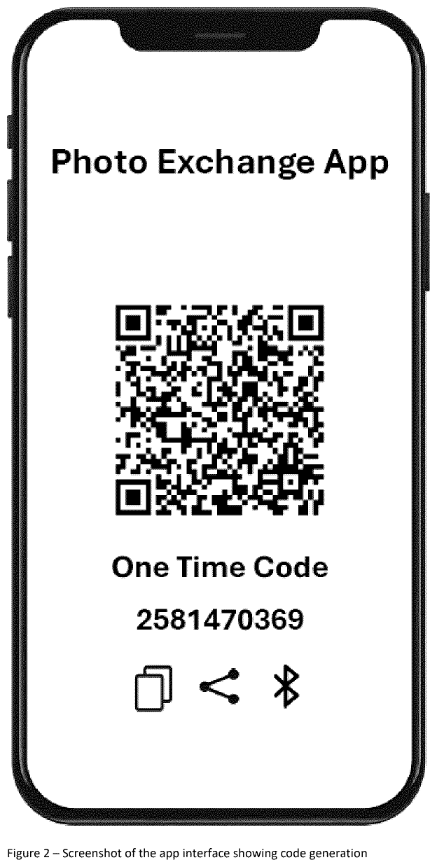

FIG. 3: Screenshot of the app interface showing the photo capture and sending process.

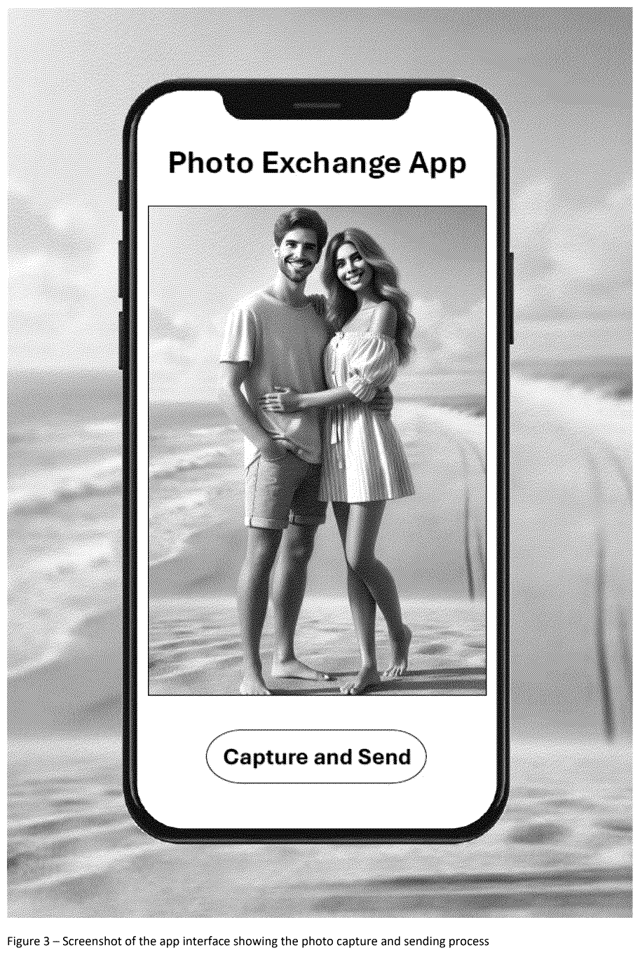

FIG. 4: System architecture diagram illustrating the interaction between mobile devices and the server.

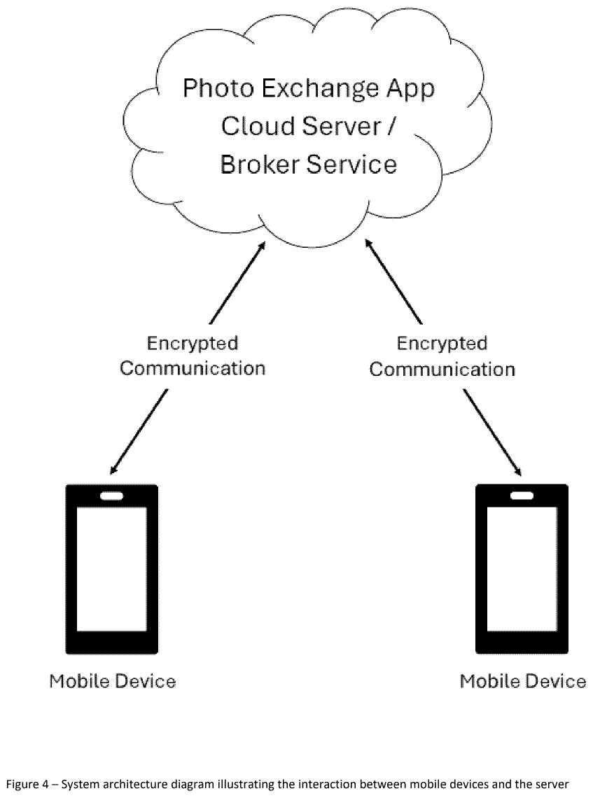

### DETAILED DESCRIPTION OF THE INVENTION

Code Generation: The application generates a cryptographically secure, random alphanumeric code. This code is associated with a specific transaction and a predetermined expiration time.

Code Exchange: The users exchange the generated code, either verbally, visually (showing the code on the screen), or through a short-range communication method like Bluetooth or NFC (Near Field Communication).

Authentication and Authorization: Upon entering the code, the application verifies its validity and grants temporary access for photo exchange between the two devices.

Photo Capture and Transfer: Users can then use their device's camera to take photos and send them directly to the other user through the application. The photos are transmitted securely using encryption.

Time Limitation: The code expires after a set period, automatically revoking access and preventing further photo exchange.

Permission Control: The application can incorporate features allowing users to grant specific permissions, such as limiting the number of photos that can be exchanged or the duration of access.

Security Measures: End-to-end encryption for photo transfer, secure code generation and storage, and measures to prevent code replay attacks.

Server Architecture: The application utilizes a secure cloud-based server for code generation, validation, and temporary storage of metadata (not the photos themselves) related to the transaction. This enhances security and scalability, while providing an audit trail for regulatory compliance and law enforcement purposes.

1. A method for secure photo exchange between two mobile devices comprising: generating a unique, time-limited code on a first mobile device; transmitting said code to a second mobile device; authenticating said code on both the first and second mobile devices; enabling photo capture and transfer between the first and second mobile devices for a predetermined time period; and invalidating said code upon expiration of said time period.

2. The method of claim 1, wherein said code is generated using a cryptographically secure random number generator.

3. The method of claim 1, further comprises encrypting the photo transfer between the first and second mobile devices.

4. A mobile application for facilitating secure photo exchange between two users, comprising: a code generation module; a code authentication module; a photo capture and transfer module; and a timer module for managing the validity of the generated code.
